(19) United States
(12) Patent Application Publication
(10) Pub. No.: US 2003/0014319 A1
(43) Pub. Date: Jan. 16, 2003

(54) Universal world wide Web user shopping cart transferable with its load from Web page to Web page

(75) Inventors: Reza Arbab, Austin, TX (US); Rene Ruben Martinez, Cedar Park, TX (US); Daniel Paul McNichol, Cedar Park, TX (US); Jessica Kelley Murillo, Hutto, TX (US); Johnny Meng-Han Shieh, Austin, TX (US)

Correspondence Address: Volel Emile, International Business Machines Corporation, Intellectual Property Law Department, 11400 Burnet Road - 4054, Austin, TX, 78758, US

(73) Assignee: International Business Machines Corporation, Armonk, NY (US)

(21) Appl. No.: 09/899,615

(22) Filed: Jul. 5, 2001

(51) Int. Cl. G06F 17/60

(52) U.S. Cl. 705/26

(57) ABSTRACT

A shopping cart is provided that is designed for the purchaser/user at the receiving Web station and is associated with the receiving display station in place of the prior art shopping cart systems that are associated with and designed for particular Web pages. The user may move his personal shopping cart from one Web page to another without checking out as he leaves the particular Web pages. The user may carry his load of products with his shopping cart as he moves the cart from Web page to Web page. An implementation at said receiving display station enables a user to load into said shopping cart a plurality of representations of products offered from said plurality of Web sites. The user at the receiving display station is enabled to select to buy a set of the loaded products and there is an implementation for transmitting to each of a plurality of Web sites offering the products selected to buy by said user, billing data required of said user to buy said products.

### TECHNICAL FIELD

The present invention relates to computer managed communication networks, such as the World Wide Web (Web), and particularly to ease of use of interactive computer controlled display interfaces to such networks for substantially reducing the time and resources required for user shopping on the Web.

### BACKGROUND OF RELATED ART

The last decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and files. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to a virtually infinite number of Web documents. In addition, Hypertext Markup Language (HTML), which had been the documentation language of the Internet or Web for years, offered direct links between pages and other documentation on the Web and a variety of related data sources of text and images. This even further exploded the use of the Web. It was now possible for the Web browser or wanderer to literally spend hours going through document after document and accompanying media events in often less than productive excursions through the Web. These excursions often strain the user's time and resources.

In addition, this rapid expansion of the Web has brought in hundreds of millions of Web users, many of whom have relatively little computer skills and sophistication. Consequently, it is critical to the continued expansion of the Web that access be as simple as possible for the unskilled users and transparent to any problems encountered in operations needed to access requested Web documents. This simplicity in interfacing with the Web must be maintained despite the fact that the rapidly expanding demand for Web facilities and resources has strained the communication capacity and resources of the Web.

A major area of complexity and potential confusion to the less sophisticated user is in trying to make purchases of goods and services through the Web. Selling to consumers over the Web still remains an E-Commerce industry of great potential, but with limited and often awkward execution. There remain many Web sites that offer products and services for sale, but each of such sites have different purchasing protocols and procedures. Often the purchasing procedures of Web sites are intermingled with technological and business data offerings, as well as other customer support functions so that making a purchase from a Web page may be very confusing, particularly to the novice user.

The E-Commerce industry has been trying to simplify selling to consumers over the Web and has developed the “Shopping Cart” concept wherein a customer entering a Web page may access a shopping cart representation into which he may load selected product representations that he will eventually arrange to pay for before leaving the Web page.

A great many Web sites provide the customer visiting the Web page or site with some sort of shopping cart for his purchases. In fact, any Web page which needs to set a shopping cart function need not develop its own cart. There are several commercial companies that will design shopping carts to conform to the needs of specific Web sites and pages. Mountain Networks and Americart are two such companies. Shopping cart services are described in further detail in the text, Internet: The Complete Reference, Millennium Edition, Margaret Young et al., Osborne/McGraw-Hill, Berkeley, Calif., 1999, at pp. 824-825.

While shopping carts have provided some ease of use for harried on-line Web shoppers, they still are frustrating to use, particularly when the Web customer plans on visiting several Web sites/pages, and especially when the user wants to do some comparison shopping. Since existing shopping carts are each specifically designed for a particular Web page, the user has to “check out” of the Web page or site that he is in and select the items in his cart that he wishes to buy before moving to another Web page. In addition, because the shopping carts are different from Web page to Web page, the user has to contend with the eccentricities of the shopping carts in each Web page. Thus, because of the many different procedures, the user cannot just learn and become familiar with just one shopping cart procedure through repetitive use.

### SUMMARY OF THE PRESENT INVENTION

The present invention provides for these shortcomings of existing shopping cart Web page purchasing systems by providing a shopping cart that is designed for the purchaser/user at the receiving Web station and is associated with the receiving display station in place of the prior art shopping cart systems that are associated with and designed for the particular Web pages. The user may move his personal shopping cart from one Web page to another without checking out as he leaves the particular Web pages. The user may carry his load of products with his shopping cart as he moves the cart from Web page to Web page.

Accordingly, the present invention provides in a Web communication network with user access through a plurality of data processor controlled user interactive receiving display stations, a system for buying products offered from a plurality of Web sites comprising means for providing a shopping cart representation at a receiving display station; means at said receiving display station enabling a user to load into said shopping cart a plurality of representations of products offered from said plurality of Web sites; means at said receiving display station enabling said user to select to buy a set of said loaded products; and means for transmitting to each of a plurality of Web sites offering the products selected to buy by said user, billing data required of said user to buy said products. The invention also provides means enabling the user to switch from one Web page offering products to another Web page offering products, in combination with means for moving said shopping cart from said one Web page to another when said user switches from said one page to another. The user may also selectively remove or delete products from his shopping cart irrespective of the Web page in which he is currently located.

All of these personal shopping cart functions may be carried out in a Web browser at the user's receiving display station or Web station. The browser may include the means for providing a shopping cart representation at a receiving display station, the means enabling a user to load into said shopping cart a plurality of representations of products offered from said plurality of Web sites, the means enabling said user to select to buy a set of said loaded products and the means for transmitting said billing data to each of a plurality of Web sites offering the products selected to buy by said user. This browser may also include the means for enabling the user to switch from one Web page offering products to another Web page offering products, and the means for moving said shopping cart from said one Web page to another when said user switches from said one page to another.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as a user interactive Web station for receiving and transmitting Web pages;

FIG. 2 is a generalized diagrammatic view of a Web portion showing how multiple Web sites providing Web pages selling products and services may be accessed to and from the Web stations through browser applications;

FIG. 3 is a diagrammatic view of a first Web page offering to sell products displayed at a receiving display station with a user's shopping cart containing a selected product;

FIG. 4 is the diagrammatic view of a second Web page offering to sell products displayed at the receiving display station with the user's shopping cart moved from the first Web page and containing products loaded from the first and second Web pages;

FIG. 5 is the diagrammatic view of a third Web page offering to sell products displayed at the receiving display station with the user's shopping cart moved from the first and second Web pages and containing products loaded from the first, second and third Web pages;

FIG. 6 is an illustrative flowchart describing the setting up of the process of the present invention for providing a personal user shopping cart for traversing Web pages and moving with selected products from Web page to Web page; and

FIG. 7 is a flowchart of an illustrative run of the process set up in FIG. 6.

### DETAILED DESCRIPTION OF THE PREFERRED EMBODIMENTS

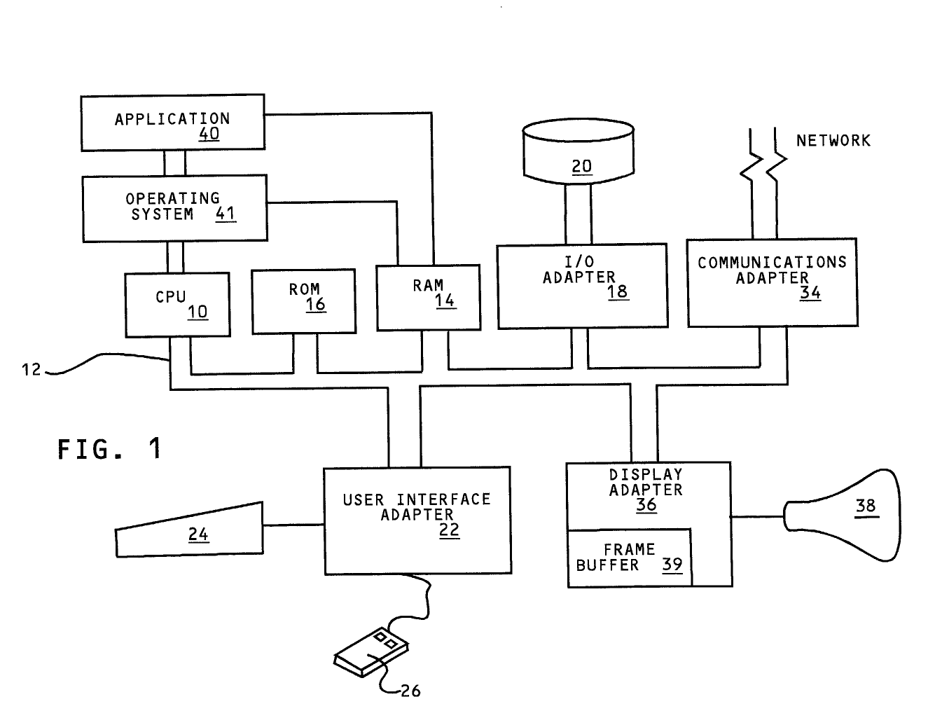

Referring to FIG. 1, a typical data processing terminal is shown which may function as a basic computer controlled network receiving terminal used in implementing the present invention for providing a user with a personal shopping cart transferable with its load from Web page to Web page. A central processing unit (CPU) 10, such as one of the PC microprocessors or workstations, e.g. RISC System/6000™ series available from International Business Machines Corporation (IBM), or Dell Corp.'s PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ operating system or Microsoft's Windows98™ or WindowsNT™, as well as UNIX and other IBM AIX operating systems. Application programs 40, controlled by the system, are moved into and out of the main memory Random Access Memory (RAM) 14. These programs include the program of the present invention which will be subsequently described in combination with any conventional Web browser, such as the Netscape 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or Wide Area Network (WAN), which includes, of course, the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for shopping on the Web according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network such as the Internet. For details on Internet nodes, objects and links, reference is made to the text, Mastering the Internet, G. H. Cady et al., published by Sybex Inc., Alameda, Calif., 1996.

Any data communication system that interconnects or links computer controlled systems with various sites defines a communications network. A network may be as simple as two linked computers or it may be any combination of LANs or WANs. Of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term documents, as used to describe data transmitted over the Web or other networks, is intended to include Web pages including displayable text, graphics and other images. Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages. In addition, aspects of this invention will involve Web browsers. A general and comprehensive description of browsers may be found in the above-mentioned Mastering the Internet text at pp. 291-313. Also, in the description that follows, reference will be made to searching and search engines.

Web searching is done through selected search engines, resident on the Web or Internet access servers. Typical search engines include Yahoo, AltaVista, Infoseek and Lycos. Such search engines are described in greater detail in the above-mentioned text, Mastering the Internet, at pp. 347-357.

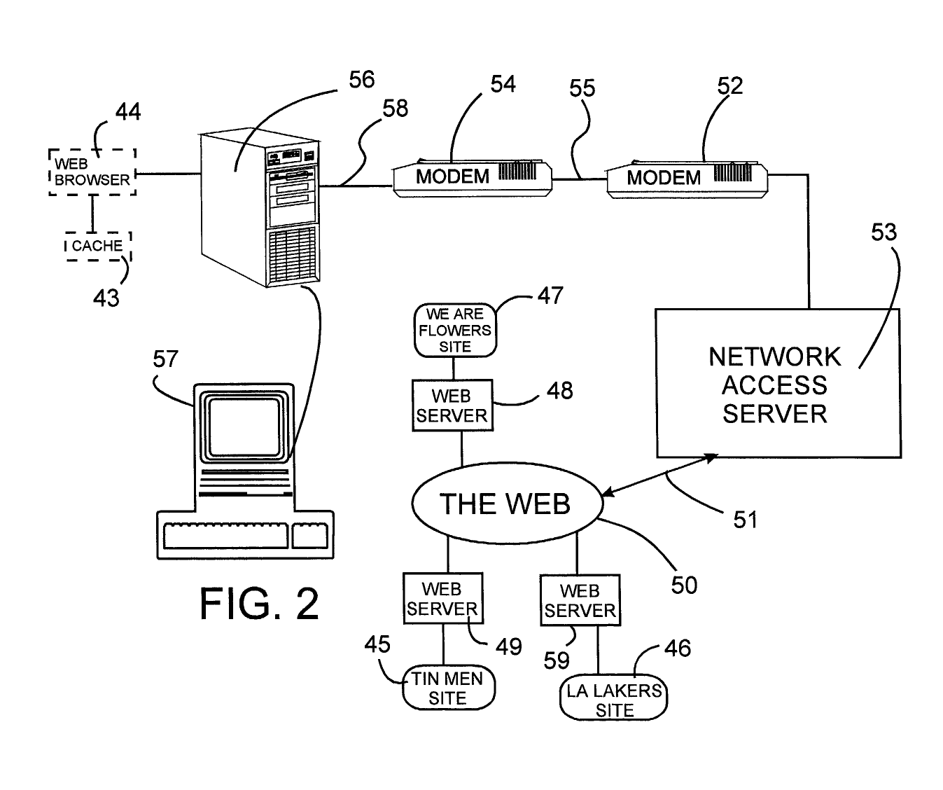

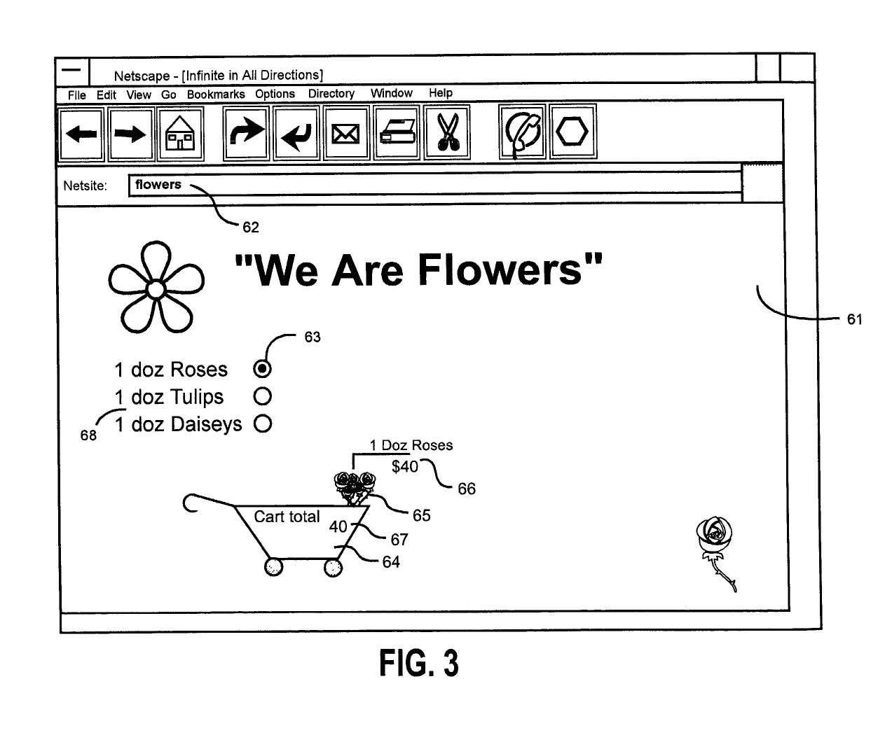

A generalized diagram of a portion of the Internet, that the computer 56 controlled display terminal 57 used for Web page or other document display of the present invention, is connected as shown in FIG. 2. Computer 56 and display terminal 57 are the computer system shown in FIG. 1 and connection 58 (FIG. 2) is the network connection shown in FIG. 1. Reference may be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial up connection. Such host-dial up connections have been in use for over 30 years through network access servers 53 which are linked 51 to the Web 50. The servers 53 are maintained by a service provider to the client's display terminal 57. The host's server 53 is accessed by the client terminal 57 through a normal dial-up telephone linkage 58 via modem 54, telephone line 55 and modem 52. The HTML files representative of the Web pages are downloaded to display terminal 57 through controlling server 53 and computer 56 via the telephone line linkages from server 53 which may have accessed them from the Web 50 via linkage 51. Three representative Web sites are shown: “We are Flowers” 47, connected to the Web via Web server 48; “Tin Men” 45, connected to the Web via Web server 49; and “LA Lakers” 46 connected to the Web via Web server 59. These will be referred to in the subsequent illustrations with respect to FIGS. 3 through 5. Web browser 44 in receiving Web station computer 56 controls the process of this invention and uses cache 43 to temporarily store data relative to the user's shopping cart.

Now, with respect to FIGS. 3 through 5, we will provide an illustrative example of how the present invention may be used to provide a universal personal shopping cart that may be moved loaded from one Web page to another. In FIG. 3, let us assume that Bea Ball wishes to buy some birthday presents for her husband. Initially, she calls up Web page 61 through the browser at her Web station. It comes from the flowers site 47 through Web server 48 in FIG. 2 as indicated at source line 62 in FIG. 3. She selects 1 doz. roses 63 from flower menu 68. She has her shopping cart 64 set up by her Web browser at her Web site. The roses representation 65 is loaded into the cart 64 along with a description and price 66. The cart provides a running total price 67 of its contents. It should be noted that the graphics for the cart and its attendant data are provided through the user's local browser rather than conventionally by the Flowers Web page itself. Under the control of the browser, the graphics engine of the local computer providing the user's Web station display provides the shopping cart and its attendant data.

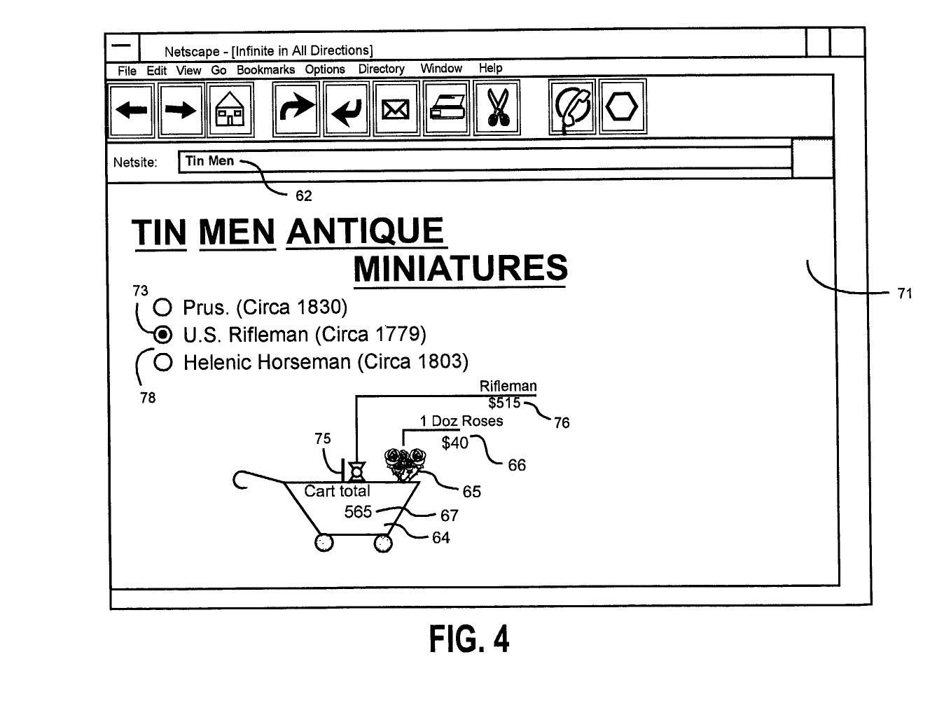

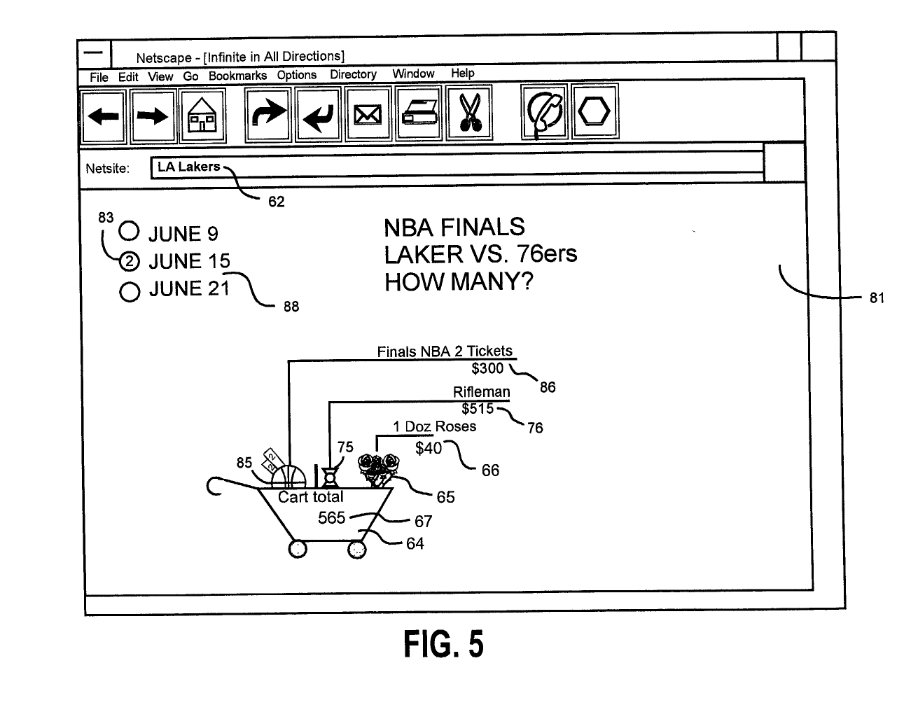

Continuing her shopping for gifts, Mrs. Ball leaves Web page 61 and has her browser call up a new Web page 71, FIG. 4. Her shopping cart 64 with its load 65 and data 66 move with the user into the new Web page 71. There, from the Tin Men page originating from Web site 45, FIG. 2, she selects item 73 from menu 78 a U.S. Rifleman antique tin soldier, a representation of which 75 ends up in her shopping cart 64 along with its attendant data 76. Further continuing her shopping for gifts, Mrs. Ball now leaves Web page 71 and has her browser call up a new Web page 81, FIG. 5. Her shopping cart 64 with its full load moves with the her into the new Web page 81. There, from the LA Laker page from Web site 46 (FIG. 2), the page offers tickets to basketball games. She selects item 83 from menu 88, two tickets to a June 15 game which is then loaded into her shopping cart as representation 85 and attendant data 86. Now she has shopped enough and wishes to have her browser finalize the sales. However, she notes that the total value of the products in her cart is listed at $865 and she has only planned to spend about $500. She decides not to take the tickets. In such a case, she may simply bring up any dialog box with a delete, for example, and then click on the ticket representation 85 to delete. Her browser is then activated to complete the sale. The browser that has stored the Web page URL, as well as the product IDs, now contacts the Web site with the user's billing information (e.g. shipping address, billing address, name and credit card information) needed to complete the sale. In the case where the user may already have an account with the Web site vendor, the billing information may be as simple as the user's ID and the IDs of the products.

The user may be offered additional information with respect to the objects in his cart. For example, if instead of one of the specialty items in her cart the user had chosen a standard item such as, let us call it, a Sony 25″ TXT TV, she could have had the option of getting the TV priced at other Web sites:

| WEB SITE | ITEM | PRICE |
|---|---|---|
| E-Mail | Sony25TXTV | $380.00 |
| TV/TV | Sony25TXTV | $353.00 |
| Fast Eddies | Sony25TXTV | $359.00 |
| Elec Outlet | Sony25TXTV | $352.00 |

In such a case, if the shopper was at the E-Mall Web page, she could readily move her cart with whatever was loaded in it to the Elec Outlet Web page, load the Sony TV at the lowest price and return the cart to E-Mall to continue shopping there.

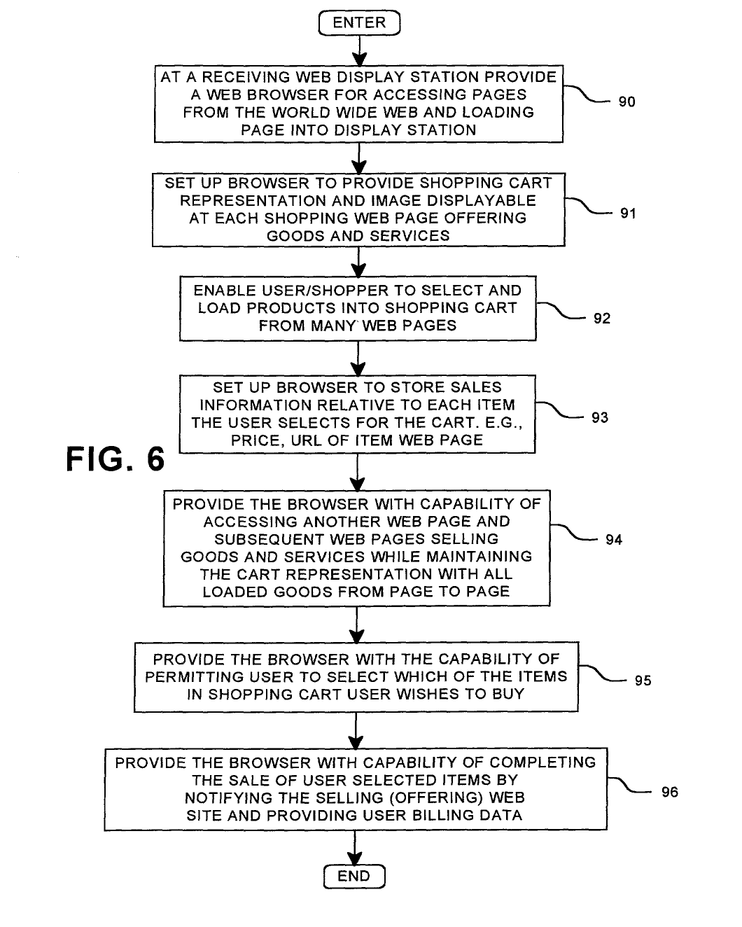

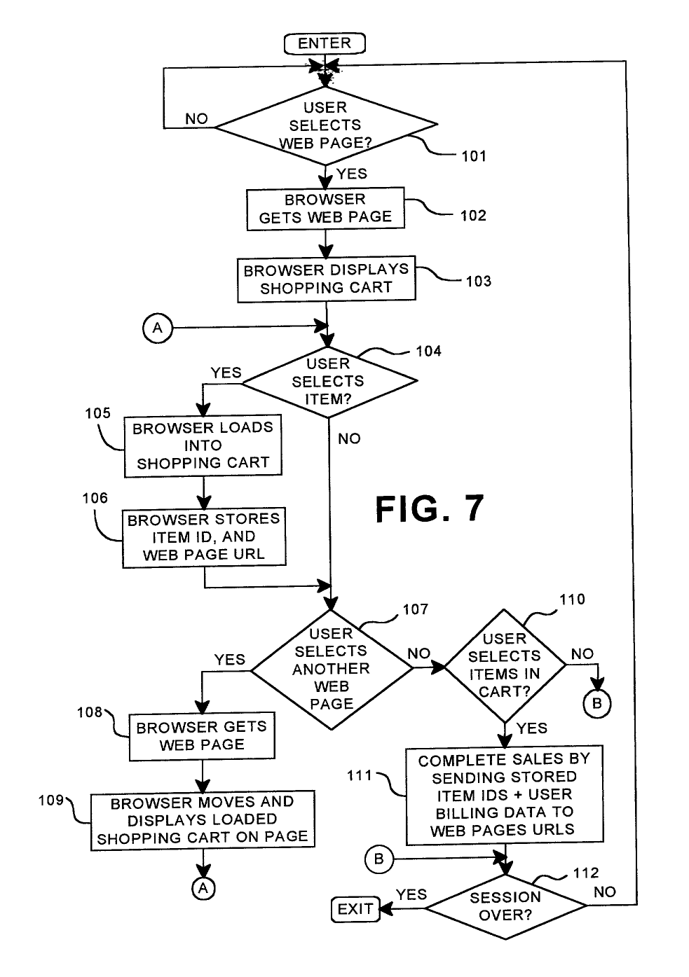

Now, with reference to FIGS. 6 and 7 we will describe a process implemented by the present invention in conjunction with the flowcharts of these figures. FIG. 6 is a flowchart showing the development of a process according to the present invention for enabling a user to move his personal shopping cart from one Web page to another. With reference to FIG. 6, first, process step 90, a conventional Web browser program is provided at the Web page receiving display station, e.g. the computer controlled display of FIG. 1 or display station 56, 57 of FIG. 2 for accessing Web pages from the Web. The browser is set up to provide a shopping cart representation and image, displayable within each accessed Web page, that is a shopping page offering goods and services, step 91. The user is enabled to select and load products into the same shopping cart from many Web page, step 92. The browser is set up to store information relative to each item that the user selects for his cart (e.g. the price, the URL of the item Web page) step 93. The browser is provided with the capability of accessing another and subsequent Web pages selling goods and services while maintaining the cart representation with all loaded goods from Web page to Web page, step 94. The browser is further provided with the capability of permitting the user to select which of the items in the shopping cart the user wishes to keep, and which the user wishes to cancel from the cart, step 95. Finally, the browser is provided with the capability of completing the sale of the user selected items by notifying the selling (offering) Web site and providing user billing data to the Web site, step 96. The running of the process will now be described with respect to FIG. 7. First, step 101, a determination is made as to whether the user has selected a Web page. If No, the process is returned to step 101, and the selection of a Web page is awaited. If Yes, the browser gets the Web page, step 102. Then, the browser displays the user's shopping cart on the page, step 103. A determination is then made, step 104, as to whether the user has selected an item from the Web page. If Yes, the browser loads the representation of the item into the cart, step 105, and the browser stores the item ID, price and Web page URL. At this point, or if the determination in step 104 is No, a determination is made as to whether the user has selected another Web page, step 107. If Yes, then the browser gets the Web page, step 108, and the browser displays the shopping cart with whatever load that it has from the previous Web page on this next Web page, step 109. Then, the process returns via branch “A” to step 104 where a determination is made as to whether the user has selected an item from this next Web page and, if Yes, then again in step 105 the item is loaded in the shopping cart along with the previous items loaded into the cart and the browser stores the data, step 106. If in step 107 the user finally does not select another Web page, then a determination is made, step 110, as to whether the user wishes to buy and thus selects items in his cart. If Yes, then, step 111, the sales are completed by the browser sending the stored item IDs and the user billing data back to the Web pages' URLs. At this point, or if the decision from step 110 had been No, via branch “B”, a determination is made as to whether the session is over, step 112. If Yes, the session is exited. If No, the process is returned to step 101 where the selection of another Web page is awaited.

One of the preferred implementations of the present invention is as a routine in an operating system made up of programming steps or instructions resident in RAM 14, FIG. 1, during computer operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access through a plurality of data processor controlled user interactive receiving display stations, a system for buying products offered from a plurality of Web sites comprising:
means for displaying a shopping cart representation at a receiving display station;
means at said receiving display station enabling a user to load into said shopping cart a plurality of representations of products offered from said plurality of Web sites;
means at said receiving display station enabling said user to select to buy a set of said loaded products; and
means for transmitting to each of a plurality of Web sites offering the products selected to buy by said user, billing data required of said user to buy said products.

2. The Web system for buying products of claim 1 wherein said Web sites offering products provide Web pages specifying the offered products.

3. The Web system for buying products of claim 2 further including:
means enabling the user to switch from one Web page offering products to another Web page offering products; and
means for moving said shopping cart from said one Web page to another when said user switches from said one page to another.

4. The Web system for buying products of claim 3 wherein said moved shopping cart includes products loaded into said shopping cart from said one page.

5. The Web system for buying products of claim 4 further including means enabling the user to selectively remove products loaded into said shopping cart.

6. The Web system for buying products of claim 4 wherein said moved shopping cart further includes cumulative cost data of the loaded products from all of said Web sites.

7. The Web system for buying products of claim 4 further comprising:
Web browsing means at said receiving display station including:
said means for displaying a shopping cart representation at a receiving display station;
said means enabling a user to load into said shopping cart a plurality of representations of products offered from said plurality of Web sites;
said means enabling said user to select to buy a set of said loaded products; and
said means for transmitting said billing data to each of a plurality of Web sites offering the products selected to buy by said user.

8. The Web system for buying products of claim 7 wherein said Web browsing means further includes:
said means enabling the user to switch from one Web page offering products to another Web page offering products; and
said means for moving said shopping cart from said one Web page to another when said user switches from said one page to another.

9. In a Web communication network with user access through a plurality of data processor controlled user interactive receiving display stations, a method for buying products offered from a plurality of Web sites comprising:
displaying a shopping cart representation at a receiving display station;
enabling a user at said receiving display station to load into said shopping cart a plurality of representations of products offered from said plurality of Web sites;
enabling said user at said receiving display station to select to buy a set of said loaded products; and
transmitting to each of a plurality of Web sites offering the products selected to buy by said user, billing data required of said user to buy said products.

10. The method for buying products of claim 9 wherein said Web sites offering products provide Web pages specifying the offered products.

11. The method for buying products of claim 10 further including the steps of:
enabling the user to switch from one Web page offering products to another Web page offering products; and
moving said shopping cart from said one Web page to another when said user switches from said one page to another.

12. The method for buying products of claim 11 wherein said moved shopping cart includes products loaded into said shopping cart from said one page.

13. The method for buying products of claim 12 further including the step of enabling the user to selectively remove products loaded into said shopping cart.

14. The method for buying products of claim 12 wherein said moved shopping cart further includes cumulative cost data of the loaded products from all of said Web sites.

15. The method for buying products of claim 11 further comprising:
a Web browsing process at said receiving display station including:
said step of displaying a shopping cart representation at a receiving display station;
said step of enabling a user to load into said shopping cart a plurality of representations of products offered from said plurality of Web sites;
said step of enabling said user to select to buy a set of said loaded products; and
said step of transmitting said billing data to each of a plurality of Web sites offering the products selected to buy by said user.

16. The method for buying products of claim 15 wherein said Web process further includes said steps of:
enabling the user to switch from one Web page offering products to another Web page offering products; and
moving said shopping cart from said one Web page to another when said user switches from said one page to another.

17. A computer program having code recorded on a computer readable medium for buying products offered from a plurality of Web sites in a Web communication network with user access via a plurality of data processor controlled interactive receiving display stations, said program comprising:
means for displaying a shopping cart representation at a receiving display station;
means at said receiving display station enabling a user to load into said shopping cart a plurality of representations of products offered from said plurality of Web sites;
means at said receiving display station enabling said user to select to buy a set of said loaded products; and
means for transmitting to each of a plurality of Web sites offering the products selected to buy by said user, billing data required of said user to buy said products.

18. The computer program of claim 17 wherein said Web sites offering products provide Web pages specifying the offered products.

19. The computer program of claim 18 further including:
means enabling the user to switch from one Web page offering products to another Web page offering products; and
means for moving said shopping cart from said one Web page to another when said user switches from said one page to another.

20. The computer program of claim 19 wherein said moved shopping cart includes products loaded into said shopping cart from said one page.

21. The computer program of claim 20 further including means enabling the user to selectively remove products loaded into said shopping cart.

22. The computer program of claim 20 wherein said moved shopping cart further includes cumulative cost data of the loaded products from all of said Web sites.

23. The computer program of claim 20 further comprising:
a Web browser program at said receiving display station including:
said means for displaying a shopping cart representation at a receiving display station;
said means enabling a user to load into said shopping cart a plurality of representations of products offered from said plurality of Web sites;
said means enabling said user to select to buy a set of said loaded products; and
said means for transmitting said billing data to each of a plurality of Web sites offering the products selected to buy by said user.

24. The computer program of claim 23 wherein said Web browser program further includes:
said means enabling the user to switch from one Web page offering products to another Web page offering products; and
said means for moving said shopping cart from said one Web page to another when said user switches from said one page to another.
